(19) United States
(12) Patent Application Publication
(10) Pub. No.: US 2023/0058263 A1
(43) Pub. Date: Feb. 23, 2023

(54) TWO-PART THERMAL CONDUCTIVE EPOXY ADHESIVE COMPOSITION

(71) Applicant: Henkel AG & Co. KGaA, Duesseldorf (DE)

(72) Inventors: Zhenfeng Cao, Shanghai (CN); Hao Wu, Shanghai (CN); Xueyu Qiu, Shanghai (CN)

(21) Appl. No.: 17/967,249

(22) Filed: Oct. 17, 2022

Related U.S. Application Data
(63) Continuation of application No. PCT/CN2020/084899, filed on Apr. 15, 2020.

(51) Int. Cl. C08L 63/00; C09J 163/00

(52) U.S. Cl. CPC C08L 63/00; C09J 163/00

(57) ABSTRACT

The present invention provides a two-part thermal conductive epoxy adhesive composition with high bonding strength and low modulus. The present invention also provides a preparing method and use thereof.

### TECHNICAL FIELD

The present invention relates to a two-part thermal conductive epoxy adhesive composition, and particularly relates to a two-part thermal conductive epoxy adhesive with high bonding strength and low modulus, the preparation method and use thereof.

### BACKGROUND OF THE INVENTION

With the deterioration of energy crisis and environmental pollution, new energy vehicle emerges and increasingly becomes an important means of transportation. In order to meet the requirements of fast charging and continuous mileage, as well as the vehicle kinetic energy under climbing, acceleration and other conditions, the battery of new energy vehicle must have high power output and large capacity. During the normal use of new energy vehicle, the battery pack constantly charges and discharges and therefore generates a lot of heat. The heat accumulates and superposes continuously, causing the temperature of battery pack rises sharply. In addition, the heat radiation condition of each piece of battery differs due to different position where each one is located, resulting in uneven temperature distribution between batteries. Hence the battery pack suffers high local temperature or uneven local cooling.

Thermal conductive material incorporated among the battery cells, battery modules, or between battery module and shield can quickly dissipate the generated heat. Therefore, the thermal conductive material is an essential part in the battery pack of new energy vehicles.

At present, most thermal conductive materials used in the battery pack of new energy vehicles are thermal conductive silicone pad, which is a polymer composite material with silicone resin as the main body mixing with thermal conductive filler. Such thermal conductive silicone pad, together with the heat sink and the structural fixing parts forms a heat dissipation module building a heat radiation path between the heat generator, i.e. battery pack module and the heat dissipation device i.e. water-cooling plate. The thermal conductive silicone pad has an acceptable thermal conductivity, stable performance and long life circle. Furthermore, the high resilience of thermal conductive silicone pad can effectively avoid the vibration, friction and damage between the cells, and the hidden danger of short circuit between the cells.

However, the thermal conductive silicone pad has three innate defects in the application of heat dissipation in the battery pack module. Firstly, the bonding strength of thermal conductive silicone gasket is not satisfactory, it is closely connected with the battery pack module and the heat dissipation device through bolts. During the installation, it is very likely that air can be brought in. Air has high thermal resistance and is a poor conductor of heat, so it greatly affects the thermal conductivity of pad and seriously hinders the heat transfer between contact surfaces. Secondly, in the process of driving, vehicles often encounter violent bumps and vibrations, which increases the risk of separation between the thermal conductive silicone pad and the upper and lower contact surfaces, which affects the thermal conductivity performance. Lastly, the research shows that under the condition of high temperature for a long time, the silicone polymer leaks oil and volatilizes small organic molecules, resulting in the decrease of electrical and resilience properties as well as thermal conductivity.

In addition, global battery manufacturers are driving to optimize the structural design of battery pack module to reduce the use of bolts, therefore, there is a need in the art for thermal conductive material to process both good thermal conductivity and high bonding strength, as well as good toughness, and in the meantime, to decrease bolts used in the installation of heat dissipation device in the battery pack modules.

### SUMMARY OF THE INVENTION

Disclosed herein is a two-part thermal conductive epoxy adhesive composition consisting of:

part A comprising

(a) at least one non-toughened epoxy resin,

(b) at least one toughened epoxy resin,

(c) at least one epoxy diluent, and

part B comprising

(d) at least one amine curing agent having the following structural formula (I):

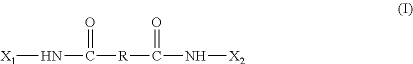

wherein R is a divalent residue of dimerized fatty acid, and X₁ and X₂ are each independently a group represented by the general formula (II):

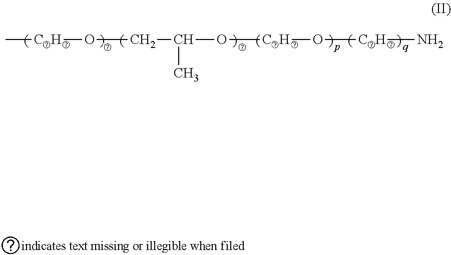

in which a and b are each independently 2 or 3, c is 1, 2 or 3, q is 0 to 4; m, n and p are each independently an integer from 0 to 6, while the sum of m+n+p=1 to 6;
wherein the ratio of amine equivalents in the component (d) to the epoxy equivalents in total amount of component (a), (b) and (c) is from 0.7 to 1.2, and
wherein the composition further comprises (e) at least one thermal conductive filler in part A and/or part B.

Also disclosed herein is the method for preparing a two-part thermal conductive epoxy adhesive according to the present invention.

Also disclosed herein is the cured two-part thermal conductive epoxy adhesive according to the present invention.

Also disclosed herein is the use of the two-part thermal conductive epoxy adhesive composition according to the present invention in bonding battery pack module of electronic car battery system.

Other features and aspects of the subject matter are set forth in greater detail below.

### DETAILED DESCRIPTION OF THE INVENTION

It is to be understood by one of ordinary skill in the art that the present invention is a description of exemplary embodiments only and is not intended as limiting the broader aspects of the present invention. Each aspect so described may be combined with any other aspect or aspects unless clearly indicated to the contrary. In particular, any feature indicated as being preferred or advantageous may be combined with any other feature or features indicated as being preferred or advantageous.

Unless specified otherwise, in the context of the present invention, the terms used are to be construed in accordance with the following definitions.

Unless specified otherwise, as used herein, the terms “a”, “an” and “the” include both singular and plural referents.

The terms “comprising” and “comprises” as used herein are synonymous with “including”, “includes” or “containing”, “contains”, and are inclusive or open-ended and do not exclude additional, non-recited members, elements or process steps.

The term “room temperature” as used herein refers to a temperature of about 20° C. to about 25° C., preferably about 25° C.

Unless specified otherwise, the recitation of numerical end points includes all numbers and fractions subsumed within the respective ranges, as well as the recited end points.

All references cited in the present specification are hereby incorporated by reference in their entirety.

Unless otherwise defined, all terms used in the present invention, including technical and scientific terms, have the meaning as commonly understood by one of the ordinary skilled in the art to which this invention belongs.

In one aspect, the present disclosure is generally directed to a two-part thermal conductive epoxy adhesive composition consisting of:

part A comprising

(a) at least one non-toughened epoxy resin,

(b) at least one toughened epoxy resin, and

(c) at least one epoxy diluent, and

part B comprising

(d) at least one amine curing agent having the following structural formula (I):

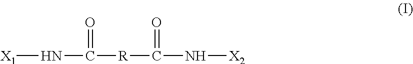

wherein R is a divalent residue of dimerized fatty acid, and X₁ and X₂ are each independently a group represented by the general formula (II):

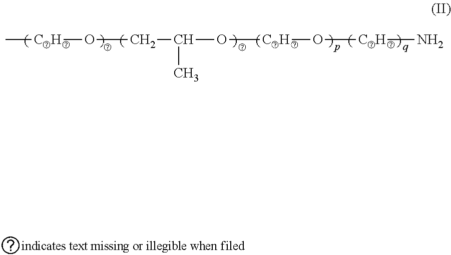

in which a and b are each independently 2 or 3, c is 1, 2 or 3, q is 0 or 1; m, n and p are each independently an integer from 0 to 6, while the sum of m+n+p=1 to 6;
wherein the ratio of amine equivalents in the component (d) to the epoxy equivalents in total amount of component (a), (b) and (c) is from 0.7 to 1.2, and
wherein the composition further comprises (e) at least one thermal conductive filler in part A and/or part B.

### (a) Non-Toughened Epoxy Resin

According to the present invention, the part A comprises (a) at least one non-toughened epoxy resin.

As used herein, the term “non-toughened epoxy resin” is understood to have not undergo a toughening treatment, either physically or chemically, and preferably have at least two glycidyl groups in one molecule.

In one embodiment, the non-toughened epoxy resin to be used in the present invention is difunctional epoxy resin, selected from bisphenol A based diglycidyl ethers, bisphenol F based diglycidyl ethers, bisphenol S based diglycidyl ethers, bisphenol Z based diglycidyl ethers, halides thereof and hydrides thereof, and a combination thereof, preferably is selected from bisphenol A based diglycidyl ethers, bisphenol F based diglycidyl ethers, and combination thereof.

Examples of commercially available products of non-toughened epoxy resin include Epon 828, Epon 826, Epon 862, (all from Hexion Co., Ltd.), DER 331, DER 383, DER 332, DER 330-EL, DER 331-EL, DER 354, DER 321, DER 324, DER 29, DER 353 (all from Dow Chemical Co., Ltd.), JER YX8000, JER RXE21, JER YL 6753, JER YL6800, JER YL980, JER 825, JER 630 (all from Japan Epoxy Resins Co., Ltd.), EP 4300E, Epichlon 830, Epichlon 830S, Epichlon 835, Epichlon EXA-830CRP, Epichlon EXA-830LVP, Epichlon EXA-835LV (all from DIC Corporation).

According to the present invention, the non-toughened epoxy resin is present in an amount of from 9% to 45%, preferably 20% to 40% by weight, based on the total weight of part A.

### (b) Toughened Epoxy Resin

According to the present invention, the part A also comprises (b) at least one toughened epoxy resin.

As used herein, the term “toughened epoxy resin” refers to an epoxy resin undergoes toughening modification or treatment by a toughening agent based on either physical or chemical mechanism. By a physical way, the toughening agent may be physically pre-dispersed in the epoxy resin matrix to form toughened epoxy resin. While through a chemical mechanism, the toughening agent may be reactive and capable of reacting substantially to the epoxy resin matrix to form chemical bonds and hence generate toughened epoxy resin. Preferably, the toughened epoxy resin used in the present invention is an epoxy resin having two or more glycidyl groups modified by toughening agent. Suitable examples of the said epoxy resin having two or more glycidyl groups are the di-, tri-, or tetra-functional epoxy resins, preferably difunctional epoxy resins, for example bisphenol A based diglycidyl ethers and bisphenol F based diglycidyl ethers. The toughening agent used to toughen the said epoxy resin can be core-shell rubber particles (physical way), or liquid butadiene rubber (chemical way), and combination thereof.

In one embodiment, the toughening agent used to toughen the epoxy resin is core-shell rubber (CSR) particles. The CSR particles preferably have a D₅₀ particle size of from 10 nm to 300 nm, more preferably from 50 nm to 200 nm. Herein, the “D₅₀ particle size” of the dispersion represents a median diameter in a volume-basis particle size distribution curve obtained by measurement with a laser diffraction particle size analyzer.

The CSR particles may have a soft core comprised of a polymeric material having elastomeric or rubbery properties, i.e. a glass transition temperature less than about 0° C., preferably less than about −30° C., and the said core is surrounded by a hard shell comprised of a non-elastomeric polymeric material (i.e., a thermoplastic or thermoset/crosslinked polymer having a glass transition temperature greater than ambient temperatures, e.g. greater than about 50° C.). Specific example of the said CRS particles is a core comprised of a diene homopolymer or copolymer (for example, a homopolymer of butadiene or isoprene, a copolymer of butadiene or isoprene with one or more ethylenically unsaturated monomers such as vinyl aromatic monomers, (meth)acrylonitrile, (meth)acrylates, or the like) surrounded by shell comprised of a polymer or copolymer of one or more monomers such as (meth)acrylates (e.g., methyl methacrylate), vinyl aromatic monomers (e.g., styrene), vinyl cyanides (e.g., acrylonitrile), unsaturated acids and anhydrides (e.g., acrylic acid), (meth)acrylamides, and the like having a suitably high glass transition temperature. The polymer or copolymer used in the shell may have acid groups that are crosslinked ionically through metal carboxylate formation (e.g., by forming salts of divalent metal cations). The shell polymer or copolymer may also be covalently crosslinked by monomers having two or more double bonds per molecule. Other elastomeric polymers may also be suitably be used for the core, including polybutylacrylate or polysiloxane elastomer (e.g., polydimethylsiloxane, particularly crosslinked polydimethylsiloxane). The particle may be comprised of more than two layers (e.g., a central core of one elastomeric material may be surrounded by a second core of a different elastomeric material or the core may be surrounded by two shells of different composition or the particle may have the structure of soft core/hard shell/soft shell/hard shell). Typically, the core comprises from about 50 to about 95 percent by weight of the particle while the shell comprises from about 5 to about 50 percent by weight of the particle. Specific example of CSR particle is methyl methacrylate-Butadiene-Styrene (MBS).

The CSR particles may be pre-dispersed in a liquid resin matrix system such as those available from Kaneka Corporation under the trademarks Kane Ace MX. Suitable commercial examples of the toughened epoxy resin include MX 120 (liquid Bisphenol A epoxy with about 25 wt. % CSR), MX 125 (liquid Bisphenol A epoxy with about 25 wt. % CSR), MX 153 (liquid Bisphenol A epoxy with about 33 wt. % CSR), MX154 (liquid Bisphenol A epoxy with about 40 wt. % CSR), MX 156 (liquid Bisphenol A epoxy with about 25 wt. % CSR), MX 130 (liquid Bisphenol F epoxy with about 25 wt. % CSR), MX 136 (liquid Bisphenol F epoxy with about 25 wt. % CSR), MX 257 (liquid Bisphenol A epoxy with about 37 wt. % CSR), MX 416 and MX 451 (liquid multifunctional epoxy with about 25 wt. % CSR), MX 215 (Epoxidized Phenol Novolac with about 25 wt. % CSR), and MX 551 (cycloaliphatic epoxy with about 25 wt. % CSR), all from Kaneka Corporation.

In some embodiments, the toughening agent used to toughen the epoxy resin can be liquid butadiene rubber. The said liquid butadiene rubber can have homo- or copolymers containing repeating units derived from butadiene or isobutadiene, or copolymers of butadiene or isobutadiene with acrylates and/or acyrlonitriles, e.g. liquid butadiene acrylonitrile rubbers.

The liquid butadiene rubber used as toughening agent in the toughened epoxy resin of the present invention may contain reactive end groups, such as amino-terminated liquid nitrile rubber (ATBN) or carboxylate-terminated liquid acrylonitrile rubber rubber (CTBN) or liquid rubbers containing free epoxy- or methacrylate end-groups.

The addition of a liquid butadiene rubber used as toughening agent in the toughened epoxy resin of the present invention is believed to improve the mechanical strength of the cured adhesive composition at elevated temperatures, in particular at temperatures of more than 90° C., preferably of more than 120° C. or even more preferably of more than 135° C.

Liquid butadiene rubbers are commercially available, for example under the trade designation of HYPOX-R from CVC Thermoset, USA.

According to the present invention, the toughened epoxy resin is present in an amount of from 10% to 30%, preferably from 15% to 25% by weight, based on the total weight of part A.

### (c) Epoxy Diluent

According to the present invention, the part A comprises (c) at least one epoxy diluent, preferably glycidyl ether-based diluent.

Suitable examples of the epoxy diluents are monoglycidyl ethers, such as phenyl glycidyl ether, alkyl phenol monoglycidyl ether, aliphatic monoglycidyl ether, alkylphenol mono glycidyl ether, alkylphenol monoglycidyl ether, 3-glycidoxypropyl trimethoxysilane, 3-glycidoxypropyl trimethoxysilane, 3-glycidoxypropylmethyldimethoxysilane; diglycidyl ethers, such as 1,4-butanediol diglycidyl ether, 1,4-cyclohexane-dimethanol, the diglycidyl ether of resorcinol, diglycidyl ether of cyclohexane dimethanol, diglycidyl ether of neopentyl glycol, triglycidyl ether of trimethylolpropane dipentene, and the divinyl ether of cyclohexanedimethanol; and tri- or tetra-glycidyl ethers, such as trimethylolpropane triglycidyl ether, glycerin triglycidyl ether, and pentaerythritol tetraglycidyl ether.

Suitable commercially available epoxy diluents are for example under the trade name of NC-513, Lite 2513HP (both from Cardolite Corporation), ED-502S, ED-509, ED-529, ED-506, ED-503, ED-523T, ED-505, ED-505R, ED-507 (all from Adeka Corporation), DY-C, DY-D, DY-E, DY-F, DY-H, DY-K, DY-L, DY-P, DY-T, DY 3601, and DY-CNO (all from Huntsman Corporation), Heloxy modifier 48, Heloxy modified 62 and Heloxy modified 65 (all from Hexion Corporation).

According to the present invention, the epoxy diluent is present in an amount of from 1% to 25% by weight, preferably 10% to 20% by weight, based on total weight of part A.

### (d) Amine Curing Agent

According to the present invention, the part B comprises (d) at least one amine curing agent having the following structural formula (I):

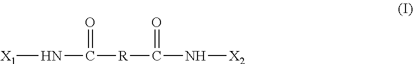

wherein R is a divalent residue of dimerized fatty acid, and X₁ and X₂ are each independently a group represented by the general formula (II):

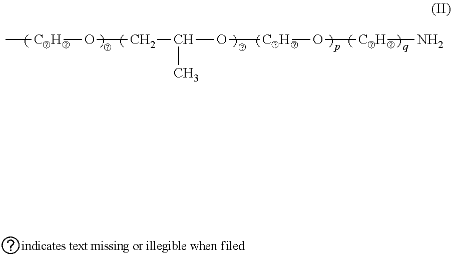

in which a and b are each independently 2 or 3, c is 1, 2 or 3, q is 0 or 1; m, n and p are each independently an integer from 0 to 6, while the sum of m+n+p=1 to 6.

The inventors have surprisingly found that the amine curing agent having the above structure can provide the adhesive composition with good bonding strength on metal substrate as well as good toughness and low modulus to the cured adhesive of the present composition.

In some embodiments, R is selected from a divalent radical of aliphatic, cycloaliphatic or aromatic hydrocarbon compound having from 2 to 48 carbon atoms, which can be prepared by the thermal polymerization of ethylenically unsaturated monocarboxylic acids having from 8 to 24 carbon atoms with monocarboxylic acid having from 16 to 20 carbon atoms.

In preferred embodiment, the amine curing agent having the structural formula (I) can be prepared by methods known to those skilled in the art. For example, it can be prepared by polymerization reaction of a dimerzed fatty acid and an excess of polyoxyalkylene polyamine. Preferably, the dimer acid has 4 to 60 carbon atoms, such as 36 carbon atoms. The polyoxyalkylene polyamine is preferably diethylene glycol di(aminopropyl)ether, triethylene glycol di(aminopropyl)ether or tetraethylene glycol di(aminopropyl)ether.

When the structural formula (I) is derived from the polymerization reaction of a dimerzed fatty acid and a polyoxyalkylene polyamine, the amine curing agent of the present invention can be a mixture of polyamide having structural formula (I) and a very small content of un-reacted polyoxyalkylene polyamine. For example, the un-reacted polyoxyalkylene polyamine in an amount of less than 35% by weight, more preferably less than 22% by weight, even more preferably less than 10% by weight, based on the weight of the amine curing agent. Preferably, no polyoxyalkylene polyamine is comprised in the amine curing agent of the present invention.

In preferred embodiments, the amine curing agent having structural formula (I) used in the present invention has a number average molecular weight (Mn) of from 500 g/mol to 10,000 g/mol, preferably from 600 g/mol to 6000 g/mol, more preferably from 700 g/mol to 2000 g/mol.

According to the present invention, the amine curing agent (d) is present in an amount of from 20% to 65%, preferably from 35% to 45% by weight, based on total weight of part B.

Commercial products of the amine curing agent (d) of the present invention are available under the trade designation Ancamide® 910 from Evonik or DOMIDE G1307 from KUKDO Chemicals. Ancamide® 910 is a mixture of at least 50% by weight of polyamide having structural formula (I) and less than 15% by weight of amino ether. DOMIDE G1307 comprises at least 80% by weight of polyamide having structural formula (I).

Further, the part B can comprise an amine curing agent different to component (d), i.e. an amine curing agent having no structural formula (I). Preferably, such amine curing agent different to part (d) has at least one primary amine group, in particular 2 to 4 primary amine group. Such amine curing agent can be diethylene glycol di(aminopropyl)ether, triethylene glycol di(aminopropyl)ether or tetraethylene glycol di(aminopropyl)ether, preferably in a very small content, as a co-curing agent for reacting with epoxy resin in the composition of the present invention. For example, the amine curing agent having no structural formula (I) can be in an amount of less than 35% by weight, more preferably less than 22% by weight, even more preferably less than 10% by weight, based on total weight of the amine curing agent. Preferably, no amine curing agent other than component (d) is comprised in the composition according to the present invention.

In some embodiments, if an amine curing agent different to component (d) is comprised in part B, component (d) is present in an amount of more than 50% by weight, preferably more than 65% by weight, more preferably more than 78% by weight, even more preferably more than 90% by weight, based on the total weight of amine curing agent.

### Ratio

According to the present invention, the ratio of amine equivalent in the component (d) to the epoxy equivalent in total amount of component (a), (b) and (c) is from 0.7 to 1.2 to achieve optimum bonding strength and low modulus performance.

In preferred embodiments the ratio of amine equivalents in the component (d) to the epoxy equivalents in total amount of component (a), (b) and (c) is from 0.8 to 1.2, more preferably is from 1.0 to 1.2.

If part B can comprise an amine curing agent different to component (d), the amine equivalents in the component (d) and the amine curing agent different to component (d) to the epoxy equivalents in total amount of (a), (b) and (c) preferably fall into the above range.

When part A comprises only two main reactants, i.e. (a) non-toughened epoxy resin and (b) toughened epoxy resin, the epoxy equivalent (EE) is calculated according to the following equation (I):

EE=Ma₁/EEWa₁+Ma₂/EEWa₂+ . . . Maₙ/EEWaₙ+Mb₁/EEWb₁+Mb₂/EEWb₂+ . . . Mbₙ/EEWbₙ (I)

### Wherein:

Ma₁ is the weight of the first (a) non-toughened epoxy resin,
EEWa₁ is the epoxy equivalent weights of the first (a) non-toughened epoxy resin,
Ma₂ is the weight of the second (a) non-toughened epoxy resin,
EEWa₂ is the epoxy equivalent weights of the second (a) non-toughened epoxy resin,
Maₙ is the weight of the n^{th} (a) non-toughened epoxy resin,
EEWaₙ is the epoxy equivalent weights of the n^{th} (a) non-toughened epoxy resin,
Mb₁ is the weight of the first (b) toughened epoxy resin,
EEWb₁ is the epoxy equivalent weights of the first (b) toughened epoxy resin
Mb₂ is the weight of the second (b) toughened epoxy resin,
EEWb₂ is the epoxy equivalent weights of the second (b) toughened epoxy resin,
Mbₙ is the weight of the n^{th} (b) toughened epoxy resin.
EEWbₙ is the epoxy equivalent weights of the n^{th} (b) toughened epoxy resin.

In addition to the above two main reactants, an epoxy diluent can be optionally comprised in a small content as a co-reactant to form part A of the present invention. In such case, the epoxy equivalent (EE) is calculated according to the following equation (II):

EE=Ma₁/EEWa₁+Ma₂/EEWa₂+ . . . Maₙ/EEWaₙ+Mb₁/EEWb₁+Mb₂/EEWb₂+ . . . Mbₙ/EEWbₙ+Mc₁/EEWc₁+ . . . Mcₙ/EEWcₙ (II)

Wherein:
Ma₁ is the weight of the first (a) non-toughened epoxy resin,
EEWa₁ is the epoxy equivalent weights of the first (a) non-toughened epoxy resin,
Ma₂ is the weight of the second (a) non-toughened epoxy resin,
EEWa₂ is the epoxy equivalent weights of the second (a) non-toughened epoxy resin,
Maₙ is the weight of the n^{th} (a) non-toughened epoxy resin,
EEWaₙ is the epoxy equivalent weights of the n^{th} (a) non-toughened epoxy resin,
Mb₁ is the weight of the first (b) toughened epoxy resin,
EEWb₁ is the epoxy equivalent weights of the first (b) toughened epoxy resin Mb₂ is the weight of the second (b) toughened epoxy resin,
EEWb₂ is the epoxy equivalent weights of the second (b) toughened epoxy resin,
Mbₙ is the weight of the n^{th} (b) toughened epoxy resin.
EEWbₙ is the epoxy equivalent weights of the n^{th} (b) toughened epoxy resin,
Mc₁ is the weight of the first (c) epoxy diluent,
EEWc₁ is the epoxy equivalent weights of the first (c) epoxy diluent,
Mcₙ is the weight of the n^{th} (c) epoxy diluent,
EEWcₙ is the epoxy equivalent weights of the n^{th}(c) epoxy diluent.

The term “epoxy equivalent weights (EEW)”, as used in the present invention, denotes the reciprocal of the equivalents of the epoxy groups contained per gram of an epoxy compound and can be measured by any known determination method. Examples of such methods include infrared (IR) spectroscopy or the HCl pyridine titration method through reaction with excess HCl in pyridine and titration of the remaining HCl with sodium methoxide, or titration in chloroform with perchloric acid in the presence of excess tetraethylammonium bromide and glacial acetic acid with an agitator of crystal violet (hexamethyl pararosaniline chloride, or by titrating a sample of the reaction product with tetrabutylammonium iodide and perchloric acid).

When only one amine compound is used as amine curing agent (d) in the in the two-part thermal conductive epoxy adhesive composition, the amine equivalent (AE) is calculated according to the following equation (III):

AE=M/AHEW (III)

Wherein:
M is the weight of amine curing agent,
AHEW is the amine hydrogen equivalent weight of amine curing agent.

When a mixture of amine compounds is used as amine curing agent (d) in the in the two-part thermal conductive epoxy adhesive composition, the amine equivalent (AE) is calculated according to the following equation (IV):

AE=M1/AHEW1+M2/AHEW2+ . . . Mn/AHEWn

### Wherein:

M1 is the weight of the first amine curing agent,
AHEW is the amine hydrogen equivalent weight of the first amine curing agent.
M2 is the weight of the second amine curing agent,
AHEW2 is the amine hydrogen equivalent weight of the second amine curing agent.
Mn is the weight of the n^{th} amine curing agent,
AHEWn is the amine hydrogen equivalent weight of n^{th} amine curing agent.

The term “amine hydrogen equivalent weight (ANEW)”, as used in the present invention, denotes molecular weight of amine divided by the number of active hydrogens in the molecule. It can be provided by the raw materials Suppliers. If the AHEW provided by Supplier is a range instead of a specific figure, then the average number of the minimum figure and maximum figure of this range will be used as AHEW to calculate the amine equivalent (AE) based on the above equation. For example, the Supplier provides the AHEW range of G1307 is from 200 to 250 g/eq, therefore, an AHEW of 225 g/eq is used to calculate the amine equivalent in the present invention.

### (e) Thermal Conductive Filler

According to the present invention, the composition comprises (e) at least one thermal conductive filler in part A and/or part B to provide thermal conductivity.

Suitable thermal conductive filler in part A or part B used in the present invention is each independently selected from silica, diatomaceous earth, alumina, zinc oxide, nickel oxide, magnesium oxide, magnesium hydroxide, aluminum hydroxide, talc, aluminum nitride, silicon nitride, boron nitride, and combination thereof.

Suitable commercially available thermal conductive fillers are sold under tradename of Martinal® ON-908, Martinal® ON-906, Martinal® ON-904 all from Huber Engineered Materials; SA-121, FY-10Y, DHRY-106, DHRY-107 all from Guangdong Foshan Jinge Fire-Fighting Material Co. Ltd, H-WF-25A, H-WF-08B from CHALCO; BAH40H4, BAH20H4, BA2, BAK20, BAK5, BA7 all from Bestry; SJR-20, SJR-4 from Anhui Estone Materials.

According to the present invention, the thermal conductive filler is present in an amount of from 35% to 80%, preferably from 45% to 70% by weight based on the total weight of composition A or B.

### Coupling Agent

The part A optionally comprises at least one coupling agent, preferably a silane coupling agent.

Suitable silane coupling agent, which can be used in the present invention include, but is not limited to, γ-aminopropyltriethoxysilane, 3-aminopropylmethyldithoxysilane, N-(2-aminoethyl)-3-aminopropylmethyl-dimethoxysilane, (aminoethylamino)-isobutyldi-methylmethoxysilane, γ-mercaptopropyltrimethoxysilane, γ-glycidoxypropyltrimethoxylsilane, phenyltrimethoxysilane, and the like.

Examples of commercial examples of silane coupling Silquest A-186 silane and Silquest A-187 silane from Momentive, KH550 and DYNASYLAN® GLYMO from Danyang City Chenguang Coincident Dose Co., Ltd.

According to the present invention, the coupling agent is present in an amount of from 0% to 0.5%, preferably from 0.1% to 0.3% by weight, based on the total weight of part A.

### Curing Accelerator

According to the present invention, the part B optionally comprises a curing accelerator to promote the curing of epoxy resin. Preferably, the curing accelerator is selected from tertiary amines, imidazole derivatives, and combination thereof.

Suitable examples of tertiary amines include trimethylamine, tri-ethylamine, tetraethylmethylenediamine, tetramethylpropane-1,3-diamine, tetra-methylhexane-1,6-diamine, pentamethyldiethylenetriamine, bis(2-dimethylaminoethyl)ether, ethylene glycol (3-dimethyl)aminopropyl ether, dimethyl-aminoethanol, dimethylaminoethoxyethanol, N,N,N′-trimethylaminoethylethanolamine, dimethylcyclohexylamine, N,N-dimethylaminomethylphenol, N,N-dimethylpropylamine, N,N,N′,N′-tetramethylhexamethylenediamine, N-methylpiperidine, N,N′-dimethylpiperazine, N,N-dimethylbenzylamine, dimethylaminomethylphenol, 2,4,6-tris(dimethylaminomethyl)phenol, 1,8-diazabicycloundecene-7, 1,5-diazabicyclo-nonene-5, dimethylpiperazine, N-methyl-N′-(2-dimethylamino)-ethylpiperazine, N-methylmorpholine, N—(N′,N′-(dimethylamino)ethyl)morpholine, N-methyl-N′-(2-hydroxyethyl)morpholine, triethylenediamine and hexamethylenetetramine.

Commercial products of tertiary amines curing accelerator are sold under the tradename of Ancamide® 54K from Evonik; KH-30, KH-76K and BDMA from KUKDO Chemicals.

According to the present invention, the curing accelerator is present in an amount of from 0% to 1%, preferably from 0.1% to 0.6% by weight, based on the total weight of part B.

### Thixotropic Agent

The two-part thermal conductive epoxy adhesive composition according to the present invention may also comprise thixotropic agent present in part A or part B or both.

Suitable thixotropic agent, which can be used in the present invention includes, but is not limited to, talc, fume silica, superfine surface-treated calcium carbonate, fine particle alumina, plate-like alumina; layered compound such as montmorillonite, spicular compound such as aluminum borate whisker, and the like. Particularly, fume silica is preferred thixotropic agent.

According to the present invention, the thixotropic agent is present in an amount of from 0% to 1%, preferably from 0.3% to 0.6% by weight, based on the total weight of part A or part B.

The composition may further comprise inorganic or organic pigments in part A or part B or both, including ferric oxide, brick dust, carbon black, titanium oxide, and combination thereof.

In some embodiments, the two-part thermal conductive epoxy adhesive composition consisting of part A comprising:

(a) from 9% to 45%, preferably 20% to 40% by weight of at least one non-toughened epoxy resin, based on the total weight of part A,

(b) from 10% to 30%, preferably from 15% to 25% by weight of at least one toughened epoxy resin, based on the total weight of part A,

(c) from 1% to 25%, preferably from 10% to 20% by weight of at least one epoxy diluent, based on total weight of part A, and

(d) from 35% to 80%, preferably from 45% to 70% by weight of at least one thermal conductive filler A, based on the total weight of part A;

and part B comprising

(e) from 20% to 65%, preferably from 35% to 45% by weight of at least one amine curing agent having the structure of Formula (I), based on the total weight of part B, and

(f) from 35% to 80%, preferably from 45% to 70% by weight of at least one thermal conductive filler B, based on the total weight of part B.

In preferred embodiments, the mixing ratio by weight of part A and part B is from about 0.7 to about 1.2, preferably from 0.8 to 1.1 and more preferably 1.0.

A further aspect of the present invention relates to a method for preparing a thermal conductive epoxy adhesive attached to a substrate of assembly, comprising the steps:
I. preparing a two-part thermal conductive epoxy adhesive composition described herein;
II. mixing part A and part B at not more than 70° C., preferably not more than 60° C., more preferably at room temperature, to form a reaction mixture; and
III. applying the reaction mixture to at least one surface of substrate, preferably selected from steel, zinc, iron, aluminum and aluminum alloys and polyethylene terephthalate.

In some embodiments, the two-parts of the thermal conductive epoxy adhesive composition of the present invention has a moderate open time, for example, from about 30 minutes to 3 hours, preferably from about 1 to 2 hours. “Open time” described herein refers to the minimum required time from when the two parts are mixed is to when installation can begin.

In some embodiments, the two parts of the thermal conductive epoxy adhesive composition are kept separated from each other and the mixing is carried out prior to immediate use, after applying the mixture to the parts to allow for the mixture curing at room temperature, optionally followed by a heat curing.

In preferred embodiments, the two-part thermal conductive epoxy adhesive composition is cured at room temperature for from 2 to 7 days. Curing can be accelerated by applying heat, for example, by heating from 60 to 100° C. for 30 minutes to 2 hours.

In the present description, the adhesive composition can be applied to the desired substrate by any convenient technique. It can be applied cold or be applied warm if desired. It can be applied by extruding or pasting it onto the substrate or other mechanical application methods such as a caulking gun. Generally, the adhesive composition of the present invention is applied to one surface of a pair of substrates, and then the substrates are contacted each other to be bonded together. After application, the adhesive composition of the present invention is cured at room temperature, optionally followed by curing at elevated temperature. Complete curing is achieved when the cohesive strength and/or adhesive strength does no longer increase.

In another aspect of the present invention, provided is a cured two-part thermal conductive epoxy adhesive having a bonding strength of more than 10.0 MPa with 100% Cohesive Failure mode on aluminum substrate and the modulus of no more than 2000 MPa, preferably no more than 1000 MPa at room temperature with frequency of 0.1 Hz and the modulus of no more than 200 MPa, preferably no more than 180 MPa at 60° C. with frequency of 0.1 Hz with the thermal conductive filler loading of more than 60%.

As referred herein, “Cohesive Failure mode” refers to that the adhesive splits and portions of the adhesive remain adhered to each of the bonded surfaces. A failure mode wherein an adhesive is removed cleanly from the substrate is referred to as “Adhesive Failure mode”. An adhesive having Cohesive Failure mode is considered to be more robust than those having Adhesive Failure mode.

In some embodiments, the cured two-part thermal conductive epoxy adhesive of the present invention has a thermal conductivity of from 0.4 to 2.0 W/m·K measured by Laser Flash LFA447 according to ASTM 14167.

In some embodiments, the cured two-part thermal conductive epoxy adhesive of the present invention has a density of from 1.2 to 2.5 g/cm³ measured according to ISO 1183.

In some embodiments, the cured two-part thermal conductive epoxy adhesive of the present invention has a good storage stability with the thermal conductive filler loading of more than 60%.

A further aspect in connection with the present invention relates to the use of the two-part thermal conductive epoxy adhesive composition according to the present invention in bonding battery pack module of electronic car battery system.

Preferred in accordance with the invention is the use of the embodiments identified earlier on above as being preferred or more preferred, for the two-part thermal conductive epoxy adhesive composition of the present invention, where preferably two or more of the aspects or corresponding features described for the two-part thermal conductive epoxy adhesive composition are combined with one another.

### EXAMPLES

The following examples are intended to assist one skilled in the art to better understand and practice the present invention. The scope of the invention is not limited by the examples but is defined in the appended claims. All parts and percentages are based on weight unless otherwise stated.

### Raw Materials:

YD-128 is liquid bisphenol A epoxy resin with an epoxy equivalent weight (EEW) of 190 q/eq. It is available from KUKDO.

MX154 is 40% polybutadiene dispersed in bisphenol A epoxy resin with an epoxy equivalent weight (EEW) of 300 q/eq. It is available from Kaneka.

Heloxy 48 is epoxy diluent with an epoxy equivalent weight (EEW) of 150 q/eq, available from Hexion.

MARTINAL® ON-908 is aluminum hydroxide used as thermal conductive filler with a D₅₀ particle size of 20 μm. It is available from Huber.

TS720 is fume silica surface treated with polydimethylsiloxane used as thixotropic agent. It is available from Cabot.

M460 is carbon black available from Cabot.

Dynasylan® GLYMO is silane coupling agent available from Evonik.

HI-54K is 2,4,6-tris-(dimethylaminomethyl) phenol used available from KEUMJUNG.

Ancamide® 910 is amine curing agent comprising more than 50% by weight of polyamide polyamine having structural formula (I), and with an amine hydrogen equivalent weight (AHEW) of 230 g/eq. It is available from Evonik.

G1307 is amine curing agents comprising more than 80% by weight of polyamide polyamine having structural formula (I), and with an amine hydrogen equivalent weight (ANEW) of from 200 to 250 g/eq. It is available from KUKDO.

Ancamide® 1922A is diethylene glycol diaminopropyl ether with an amine hydrogen equivalent weight (AHEW) of 55 g/eq. It is available from Evonik.

Ancamide® 2766 is modified cycloaliphatic polyamide curing agent with an amine hydrogen equivalent weight (AHEW) of 120 g/eq. It is available from Evonik.

Jeffamine® D230 is polyetheramine, with an amine hydrogen equivalent weight (ANEW) of 60 g/eq. It is available from Huntsman.

Versamide® 140 is polyamide resin based on dimerized fatty acid and polyamines with no ether groups, and with an amine hydrogen equivalent weight (AHEW) of 100 g/eq. It is available from GABRIEL PHENOXIES INC.

### Test Methods:

### Modulus:

The modulus at room temperature and 60° C. of the two-part thermal conductive epoxy adhesive of the present invention was determined by Dynamic Mechanical Analysis machine (Perkin Elmer). The part A and part B of the present invention were mixed and then put into a 15 mm×5 mm×1 mm aluminium mould followed by cured in room temperature for 7 days. Cured samples were removed from mould and tested in DMA machine with tensile mode scanning from temperature 20° C. to 80° C. under 0.1 Hz frequency.

It will be evaluated as acceptable if the modulus at room temperature with frequency of 0.1 Hz is no more than 2000 MPa and the modulus at 60° C. with frequency of 0.1 Hz is no more than 200 MPa.

### Lap Shear Strength:

The lap shear strength of the cured samples of the present invention was determined according to GBT7124 using an Instron tensile tester Model 5996 at crosshead speed of 10 mm/min, the test results were recorded in MPa.

The cured samples of the present invention were applied on one end of a test strip using a spatula followed by overlapping the ends of the second strip with the end of the first strip. The two ends were pressed against each other forming an overlap of 12.7 mm. The adhesive thickness was 0.25 mm determined by spacer.

The cohesive strength was measured on 100 mm×25 mm×2 mm test strips of aluminium 3003 clad (available from Baiside Company, DongGuan, China) without any treatment on substrates.

The cured sample having a bonding strength of more than 10.0 MPa with 100% Cohesive Failure mode can be acceptable.

### Density:

The density of cured samples of the present invention was tested with balance by immersion method according to ISO 1183. The density of from 1.2 to 2.5 g/cm³ can be acceptable.

### Thermal Conductivity Performance:

The thermal conductivity of cured samples of the present invention was tested by Laser Flash LFA447 according to ASTM 1461. The conductivity of from 0.4 to 2.0 W/m·K can be acceptable.

### Storage Stability Test:

300 g cured samples was put into a container in the oven under 55° C. for 1 month. Then a spatula was used to check whether any obvious precipitates appear. if obvious precipitates appeared, the sample would fail to pass the storage stability test. If no obvious precipitates occur, a rheology was used to further measure the viscosity change. If the change of viscosity was less than 20%, the sample would pass the storage stability test. If not, the sample would fail to pass the storage stability test.

### Examples 1 to 8 (Ex. 1 to Ex. 8) and Comparative Examples 1 to 5 (CEx. 1 to CEx. 5)

The thermal conductive epoxy adhesives of the present invention were formed by mixing the part A and part B in amounts (wt. %) listed in the Table 1 at a room temperature with the mixing ratio of 1:1 by weight and cured at room temperature for seven days. The properties were tested using the methods stated above, and the results of evaluations were shown in Table 1.

TABLE 1

| Ingredients | | EX. 1 | EX. 2 | CEx. 1 | CEx. 2 | CEx. 3 | CEx. 4 |
|---|---|---|---|---|---|---|---|
| Part A | | | | | | | |
| YD128 | | 15.69 | 15.69 | 15.69 | 15.69 | 15.69 | 15.69 |
| MX154 | | 9.42 | 9.42 | 9.42 | 9.42 | 9.42 | 9.42 |
| Heloxy 48 | | 6.28 | 6.28 | 6.28 | 6.28 | 6.28 | 6.28 |
| MARTINAL | | 67.80 | 67.80 | 67.80 | 67.80 | 67.80 | 67.80 |
| ON ®-908 | | | | | | | |
| TS720 | | 0.13 | 0.13 | 0.13 | 0.13 | 0.13 | 0.13 |
| M460 | | 0.06 | 0.06 | 0.06 | 0.06 | 0.06 | 0.06 |
| DYNASYLAN ® GLYMO | | 0.63 | 0.63 | 0.63 | 0.63 | 0.63 | 0.63 |
| Part B | | | | | | | |
| HI-54K | | 0.70 | 0.70 | 0.76 | 0.58 | 0.74 | 0.71 |
| TS720 | | 0.28 | 0.28 | 1.01 | 0.47 | 0.98 | 0.56 |
| MARTINAL ® ON-908 | | 64.86 | 64.86 | 62.97 | 64.03 | 61.43 | 63.47 |
| Ancamide ® 910 | | 34.16 | — | — | — | — | — |
| G1307 | | — | 34.16 | — | — | — | — |
| Ancamine ® 1922A | | — | — | 35.26 | — | — | — |
| Ancamide ® 2766 | | — | — | — | 34.92 | — | — |
| Jeffamine ® D230 | | — | — | — | — | 36.86 | — |
| Versamide ® 140 | | — | — | — | — | — | 35.26 |
| ratio of amine equivalent | | 1.0 | 1.0 | 1.0 | 1.0 | 1.0 | 1.0 |
| to the epoxy equivalent | | | | | | | |
| Testing Results | | | | | | | |
| Modulus (MPa) | | 500 | 340 | 8700 | 9800 | 4200 | 7800 |
| @room | | | | | | | |
| temperature, | | | | | | | |
| with frequency | | | | | | | |
| of 0.1 Hz | | | | | | | |
| Modulus (MPa) | | 168 | 140 | 250 | 1700 | 220 | 320 |
| @60° C., with | | | | | | | |
| frequency of | | | | | | | |
| 0.1 Hz | | | | | | | |
| Lap shear strength/ | | CF | CF | CF | AF | CF | AF |
| Failure mode | | | | | | | |
| Lap shear strength on | | 13.31 | 12.8 | 12.97 | 7.21 | 12.36 | 6.27 |
| 3003 Al (MPa) | | | | | | | |
| Thermal conductivity | | 0.8 | 0.8 | 0.8 | 0.8 | 0.8 | 0.8 |
| (W/m · K) | | | | | | | |
| Density (kg/m³) | | 1.6 | 1.6 | 1.6 | 1.6 | 1.6 | 1.6 |
| Storage Stability | | Pass | Pass | Pass | Pass | Pass | Pass |
| Test | | | | | | | |
| Ingredients | EX. 3 | EX. 4 | EX. 5 | EX. 6 | EX. 7 | EX. 8 | CEx. 5 |
| Part A | | | | | | | |
| YD128 | 15.69 | 15.69 | 15.69 | 15.69 | 15.69 | 15.69 | 15.69 |
| MX154 | 9.42 | 9.42 | 9.42 | 9.42 | 9.42 | 9.42 | 9.42 |
| Heloxy 48 | 6.28 | 6.28 | 6.28 | 6.28 | 6.28 | 6.28 | 6.28 |
| MARTINAL | 67.80 | 67.80 | 67.80 | 67.80 | 67.80 | 67.80 | 67.80 |
| ON ®-908 | | | | | | | |
| TS720 | 0.13 | 0.13 | 0.13 | 0.13 | 0.13 | 0.13 | 0.13 |
| M460 | 0.06 | 0.06 | 0.06 | 0.06 | 0.06 | 0.06 | 0.06 |
| DYNASYLAN ® | 0.63 | 0.63 | 0.63 | 0.63 | 0.63 | 0.63 | 0.63 |
| GLYMO | | | | | | | |
| Part B | | | | | | | |
| K54 | 0.99 | 0.86 | 0.76 | 0.70 | 0.62 | 0.57 | 0.52 |
| TS720 | 0.39 | 0.34 | 0.30 | 0.28 | 0.25 | 0.23 | 0.21 |
| MARTINAL ®ON- | 64.10 | 64.43 | 64.69 | 64.86 | 65.06 | 65.19 | 65.31 |
| 908 | | | | | | | |
| Ancamide ® 910 | 34.52 | 34.36 | 34.25 | 34.16 | 34.08 | 34.01 | 33.96 |
| ratio of amine | 0.7 | 0.8 | 0.9 | 1.0 | 1.1 | 1.2 | 1.3 |
| equivalent to the | | | | | | | |
| epoxy equivalent | | | | | | | |
| Testing Result | | | | | | | |
| Modulus (MPa) | 2000 | 900 | 690 | 500 | 200 | 160 | 130 |
| @room | | | | | | | |
| temperature, | | | | | | | |
| with frequency | | | | | | | |
| of 0.1 Hz | | | | | | | |
| Modulus (MPa) | 200 | 160 | 155 | 168 | 120 | 118 | 100 |
| @60° C., with | | | | | | | |
| frequency of | | | | | | | |
| 0.1 Hz | | | | | | | |
| Lap shear | CF | CF | CF | CF | CF | CF | AF |
| strength/Failure | | | | | | | |
| mode | | | | | | | |
| Lap shear | 14.3 | 14.0 | 13.3 | 13.2 | 12.7 | 12.8 | 9.6 |
| strength (MPa) | | | | | | | |
| Thermal | 0.8 | 0.8 | 0.8 | 0.8 | 0.8 | 0.8 | 0.8 |
| conductivity | | | | | | | |
| (W/m · K) | | | | | | | |
| Density (kg/m³) | 1.6 | 1.6 | 1.6 | 1.6 | 1.6 | 1.6 | 1.6 |
| Storage Stability | Pass | Pass | Pass | Pass | Pass | Pass | Pass |
| Test | | | | | | | |

As can be seen from Tables 1, the thermal conductive epoxy adhesive of the present invention showed high bonding strength, low modulus, low density, and good thermal conductivity performance.

Comparative examples 1 to 5 (CEx. 1 to CEx. 5), in which different amine curing agents were used (CEx. 1 to CEx. 4) or the ratio of amine equivalent in the amine curing agent (d) to the epoxy equivalent in total amount of component (a), (b) and (c) was not within 0.7 to 1.2 (CEx. 5) all showed one or more unsatisfied properties compared with the thermal conductive epoxy adhesive of the present invention.

Although some preferred embodiments have been described, many modifications and variations may be made thereto in light of the above teachings. It is therefore to be understood that the invention may be practiced otherwise than as specifically described without departing from the scope of the appended claims.

What is claimed is:

1. A two-part thermal conductive epoxy adhesive composition consisting of:
part A comprising
(a) at least one non-toughened epoxy resin,
(b) at least one toughened epoxy resin,
(c) at least one epoxy diluent, and
part B comprising
(d) at least one amine curing agent having the following structural formula (I): 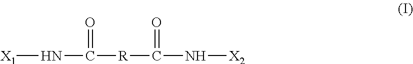
wherein R is a divalent residue of dimerized fatty acid, and X₁ and X₂ are each independently a group represented by the general formula (II): 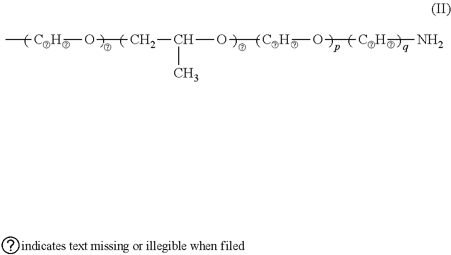
in which a and b are each independently 2 or 3, c is 1, 2 or 3, q is 0 or 1; m, n and p are each independently an integer from 0 to 6, while the sum of m+n+p=1 to 6;
wherein the ratio of amine equivalents in the component (d) to the epoxy equivalents in total amount of component (a), (b) and (c) is from 0.7 to 1.2, and
wherein the composition further comprises (e) at least one thermal conductive filler in part A and/or part B.

2. The two-part thermal conductive epoxy adhesive composition according to claim 1, wherein the non-toughened epoxy resin (a) is selected from bisphenol A based diglycidyl ethers, bisphenol F based diglycidyl ethers, bisphenol S based diglycidyl ethers, bisphenol Z based diglycidyl ethers, halides thereof and hydrides thereof, and combination thereof.

3. The two-part thermal conductive epoxy adhesive composition according to claim 1, wherein the toughened epoxy resin (b) is an epoxy resin having two or more glycidyl groups toughened by at least one toughening agent selected from core shell rubber, liquid butadiene rubber, and combination thereof.

4. The two-part thermal conductive epoxy adhesive composition according to claim 1, wherein the epoxy diluent (c) is selected from monoglycidyl ethers, diglycidyl ethers, tri-glycidyl ethers, and combination thereof.

5. The two-part thermal conductive epoxy adhesive composition according to claim 1, wherein R in the structural formula (I) is selected from a divalent radical of aliphatic, cycloaliphatic or aromatic hydrocarbon compound having from 2 to 48 carbon atoms.

6. The two-part thermal conductive epoxy adhesive composition according to claim 1, wherein the amine equivalents in the component (d) to the epoxy equivalents in total amount of component (a), (b) and (c) is from 0.8 to 1.2.

7. The two-part thermal conductive epoxy adhesive composition according to claim 1, wherein the part B further comprises at least one amine curing agent different to component (d).

8. The two-part thermal conductive epoxy adhesive composition according to claim 7, wherein the component (d) is present in an amount of more than 50% by weight, based on the total weight of the amine curing agents.

9. The two-part thermal conductive epoxy adhesive composition according to claim 7, wherein the amine equivalents in the component (d) and the amine curing agent different to component (d) to the epoxy equivalents in total amount of component (a), (b) and (c) is from 0.7 to 1.2.

10. The two-part thermal conductive epoxy adhesive composition according to claim 1, wherein the number average molecular weight (Mn) of the component (d) is from 500 g/mol to 10,000 g/mol.

11. The two-part thermal conductive epoxy adhesive composition according to claim 1, wherein the thermal conductive filler (e) in part A and/or part B is each independently selected from silica, diatomaceous earth, alumina, zinc oxide, nickel oxide, magnesium oxide, magnesium hydroxide, aluminum hydroxide, talc, aluminum nitride, silicon nitride, boron nitride, and combination thereof.

12. The two-part thermal conductive epoxy adhesive composition according to claim 1, wherein the part A further comprises at least one coupling agent.

13. The two-part thermal conductive epoxy adhesive composition according to claim 1, wherein the part B further comprises at least one curing accelerator.

14. The two-part thermal conductive epoxy adhesive composition according to claim 1, wherein the part A and/or part B further contain thixotropic agent.

15. The two-part thermal conductive epoxy adhesive composition according to claim 1, wherein the non-toughened epoxy resin (a) is present in an amount of from 9% to 45% by weight based on the total weight of part A.

16. The two-part thermal conductive epoxy adhesive composition according to claim 1, wherein the toughened epoxy resin (b) is present in an amount of from 10% to 30% by weight based on the total weight of composition A.

17. The two-part thermal conductive epoxy adhesive composition according to claim 1, wherein the amine curing agent (d) is present in an amount of from 20% to 65% by weight based on the total weight of composition B.

18. The two-part thermal conductive epoxy adhesive composition according to claim 1, wherein the thermal conductive filler (e) is presented in an amount of from 35% to 80% by weight based on the total weight of the composition A or B.

19. A method for preparing an assembly including the thermal conductive epoxy adhesive according to claim 1 attached to a substrate, comprising the steps:
I. preparing the two-part thermal conductive epoxy adhesive composition;
II. mixing part A and part B at not more than 70° C. to form a reaction mixture; and
III. applying the reaction mixture to at least one surface of substrate.

20. An assembly obtained by the method according to claim 19.
